(19) United States
(12) Patent Application Publication
(10) Pub. No.: US 2022/0152892 A1
(43) Pub. Date: May 19, 2022

(54) METHOD FOR MANUFACTURING RESIN-FRAMED GLASS PLATE

(71) Applicant: AGC Inc., Tokyo (JP)

(72) Inventor: Kazuhiro TAKAHASHI, Tokyo (JP)

(73) Assignee: AGC Inc., Tokyo (JP)

(21) Appl. No.: 17/592,192

(22) Filed: Feb. 3, 2022

Related U.S. Application Data
(63) Continuation of application No. PCT/JP2020/028540, filed on Jul. 22, 2020.

(30) Foreign Application Priority Data
Aug. 8, 2019 (JP) 2019-145980

(51) Int. Cl. B29C 45/14; B60J 1/10; B60J 10/70

(52) U.S. Cl. CPC B29C 45/14; B29L 2031/3052; B60J 10/70; B60J 1/10

(57) ABSTRACT

A process for producing a glass plate with a resin frame disposed on a peripheral edge portion, and the glass plate is configured to be mounted to a vehicle, includes using a mold to clamp a portion of the glass plate adjacent to the peripheral edge portion to form a cavity space between an inner surface of the mold and the peripheral edge portion of the glass plate; placing a hollow molding in the mold to be apart from the glass plate and to expose at least a portion of the hollow molding to the cavity space, the hollow molding including a hollow portion and having a support member placed into the hollow portion; injecting a resin material into the cavity space, and solidifying the resin material to form a base member, wherein the hollow molding, the base member and the glass plate are unified.

### CROSS-REFERENCE TO RELATED APPLICATIONS

This application is a Bypass Continuation of PCT Application No. PCT/JP2020/028540, filed on Jul. 22, 2020, which is based upon and claims the benefit of priority from Japanese Patent Application No. 2019-145980 filed on Aug. 8, 2019. The contents of those applications are incorporated herein by reference in their entireties.

### TECHNICAL FIELD

The present invention relates to a process for producing a glass plate with a resin frame.

### BACKGROUND ART

Various proposals have been made about a glass plate having a resin member disposed on a peripheral edge portion for a window for a vehicle such as an automobile. For example, Patent Document 1 listed below discloses a glass plate module, which includes a glass plate having a resin member disposed on a peripheral edge portion, and a hollow molding fixed to the resin member. When a door adjacent to the glass plate module is closed, the door applies a load to the hollow molding, resulting in deformation of the hollow molding. The hollow molding has a hollow portion formed therein.

### PRIOR ART DOCUMENTS

### Patent Documents

Patent Document 1: WO 2018/131641

### DISCLOSURE OF INVENTION

### Technical Problem

Patent Document 1 recites that the hollow molding is attached to the resin member by a double-sided adhesive tape. Because the hollow molding is likely to be deformed, it has been difficult to use such a double-sided adhesive tape to make attachment with a high accuracy in some cases.

The present invention is proposed in consideration of such circumstances. It is an object of the present invention to provide a process for producing a glass plate with a resin frame having a high attachment accuracy.

### Solution to Problem

The process for producing a glass plate with a resin frame, wherein the glass plate has a resin frame disposed on a peripheral edge portion, and the glass plate is configured to be mounted to a vehicle, according to a first mode, includes using a mold to clamp a portion of the glass plate adjacent to the peripheral edge portion so as to form a cavity space between an inner surface of the mold and the peripheral edge portion of the glass plate; placing a hollow molding in the mold so as to be apart from the glass plate and to expose at least a portion of the hollow molding to the cavity space, the hollow molding including a hollow portion and having a support member placed into the hollow portion; injecting a resin material into the cavity space of the mold, and solidifying the resin material to form a base member so as to produce a glass plate with a resin frame wherein the hollow molding, the base member and the glass plate are unified; taking the glass plate with a resin frame out of the mold; and removing, out of the hollow portion, the support member placed in the hollow portion.

The process for producing a glass plate with a resin frame, wherein the glass plate has a resin frame disposed on a peripheral edge portion, and the glass plate is configured to be mounted to a vehicle, according to a second mode, includes using a first mold to clamp a portion of the glass plate adjacent to the peripheral edge portion so as to form a cavity space between an inner surface of the first mold and the peripheral edge portion of the glass plate; injecting a first resin material into the cavity space of the first mold, and solidifying the first resin material to form a base member so as to produce a glass plate with a base member wherein the base member and the glass plate are unified; using a second mold to clamp a portion of the glass plate with the base member, adjacent to the peripheral edge portion, along with at least a portion of the base member, so as to form a cavity space between an inner surface of the second mold and the peripheral edge portion of the glass plate with the base member, injecting a second resin material into the cavity space of the second mold, solidifying the second resin material to form a hollow molding having a hollow portion so as to produce a glass plate with a resin frame wherein the hollow molding, the base member and the glass plate are unified; and taking the glass plate with a resin frame out of the second mold.

The process for producing a glass plate with a resin frame, wherein the glass plate has a resin frame disposed on a peripheral edge portion, and the glass plate is configured to be mounted to a vehicle, according to a third mode, includes using a first mold to clamp a portion of the glass plate adjacent to the peripheral edge portion so as to form a cavity space between an inner surface of the first mold and the peripheral edge portion of the glass plate; injecting a first resin material into the cavity space of the first mold, and solidifying the first resin material to form a base member so as to produce a glass plate with a base member wherein the base member and the glass plate are unified; using a second mold to clamp a portion of the glass plate with the base member, adjacent to the peripheral edge portion, along with at least a portion of the base member, so as to form a cavity space between an inner surface of the second mold and the peripheral edge portion of the glass plate with the base member; injecting a second resin material into the cavity space of the second mold, the second resin material at least partly containing a resin foaming material, and solidifying the second resin material to form a molding so as to produce a glass plate with a resin frame wherein the molding, the base member and the glass plate are unified; and taking the glass plate with a resin frame out of the second mold.

### Advantageous Effects of Invention

In accordance with the present invention, it is possible to produce, with a high attachment accuracy, a glass plate with a resin frame.

### BRIEF DESCRIPTION OF DRAWINGS

FIG. 1 is a front view illustrating a glass plate with a resin frame.

FIG. 2 is a cross-sectional view taken along line II-II of FIG. 1.

FIG. 3 is a schematic view illustrating some steps in the process for producing a glass plate with a resin frame according to a first embodiment.

FIG. 4 is a schematic view illustrating some steps in the process for producing a glass plate with a resin frame according to the first embodiment.

FIG. 5 is a schematic view illustrating some steps in the process for producing a glass plate with a resin frame according to a second embodiment.

FIG. 6 is a schematic view illustrating some steps in the process for producing a glass plate with a resin frame according to the second embodiment.

FIG. 7 is a schematic view illustrating some steps in the process for producing a glass plate with a resin frame according to a third embodiment.

FIG. 8 is a schematic view illustrating some steps in the process for producing a glass plate with a resin frame according to the third embodiment.

FIG. 9 is a schematic view illustrating some steps in the process for producing a glass plate with a resin frame according to a fourth embodiment.

FIG. 10 is a schematic view illustrating some steps in the process for producing a glass plate with a resin frame according to the fourth embodiment.

### DESCRIPTION OF EMBODIMENTS

Now, preferred embodiments of the glass plate with a resin frame according to the present invention will be described in reference to the accompanying drawings. In Description, the wordings of “upward (U)”, “downward (D)”, “forward (F)”, “rearward (R)”, “inward (In)” and “outward (Out)”, which are indicative of directions or positions, mean directions or positions in a case where the glass plate with a resin frame is mounted to a vehicle.

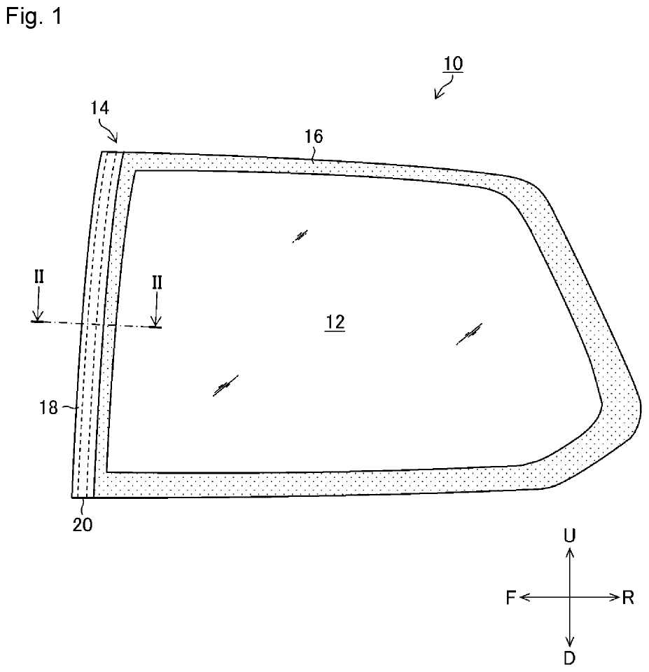

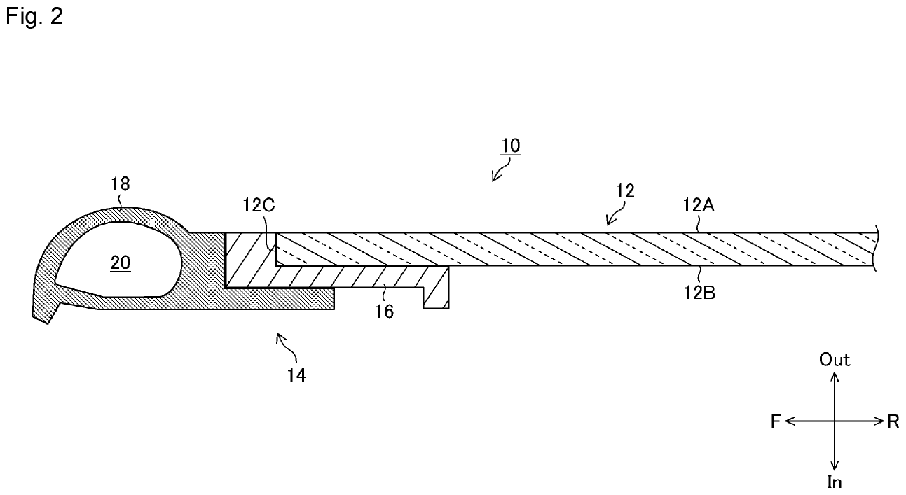

FIG. 1 is a plan view illustrating an embodiment of the glass plate with a resin frame, which is produced according to the process for producing a glass plate with a resin frame. FIG. 2 is a cross-sectional view taken along line 2-2 of FIG. 2.

As shown in FIG. 1, the glass plate with a resin frame 10, which is configured to be mounted to a vehicle, includes a glass plate 12 and a resin frame 14. The resin frame 14 includes a base member 16 attached to a peripheral edge portion of the glass plate 12, and a hollow molding 18 attached to the base member 16.

The glass plate 12 is formed in a shape adapted to the shape of a vehicle window frame, to which the glass plate is mounted. There is no limitation to the shape of the glass plate 12 in plan view. The plan view means a view that is seen from one of opposite principal surfaces of the glass plate 12.

The base member 16 is attached to the glass plate 12 so as to surround the entire peripheral edge portion of the glass plate. In Description, the base member 16 means a gasket, a molding, a weather strip or the like, which is configured to be attached to the peripheral edge portion of the glass plate 12 for blocking a gap between the vehicle window frame and the glass plate. The base member 16 may be attached to the entire peripheral edge portion or a portion of the peripheral edge portion of the glass plate 12.

The hollow molding 18 may be attached to at least a portion of the base member 16. The hollow molding 18 is disposed at a position adjacent to a vehicle door (not show) so as to be brought into contact with the door when the glass plate with a resin frame 10 is mounted to the vehicle. In the mode shown in FIG. 1, the hollow molding 18 is attached to the base member 16 along a portion of the base member 16 corresponding to one side of the glass plate 12. It should be noted that the glass plate with a resin frame 10 may be disposed at a position except the position adjacent to a vehicle door. The glass plate with a resin frame 10 may be a roof glass. When the glass plate with a resin frame 10 is a roof glass, the hollow molding 18 is attached to a position where the glass plate with a resin frame 10 is brought into contact with the roof panel.

As shown in FIG. 2, the glass plate 12 includes a first surface 12A facing an exterior side, a second surface 12B facing an interior side, and an end surface 12C connecting the first surface 12A and the second surface 12B. The first surface 12A and the second surface 12B form opposite principal surfaces.

The base member 16 is attached to the peripheral edge portion of the glass plate 12. The peripheral edge portion extends in a range of preferably 3 mm to 50 mm inwardly from the end surface 12C of the glass plate 12 from the viewpoint of ensuring bond strength with the glass plate 12. The peripheral edge portion extends in a range of more preferably 3 mm to 10 mm inwardly from the end surface 12C of the glass plate 12 in consideration of breakage or the like in the glass plate 12, which could be caused when the base member 16 is integrally molded to the glass plate. The base member 16 has a portion in contact with the second surface 12B and a portion in contact with the end surface 12C in sectional view. The base member 16 is formed in a substantially L-shape in contact with the glass plate 12 on two surfaces. There is no particular limitation to the shape of the base member 16. For example, the base member 16 may have respective portions in contact with the first surface 12A, the end surface 12C and the second surface 12B. In this mode, the base member is formed in a substantially U-shape in contact with the glass plate on three surfaces. The base member 16 is integrally molded to the glass plate 12 as described later.

As shown in FIG. 2, the hollow molding 18 is attached to the base member 16 in the glass plate with a resin frame 10. The hollow molding 18 is brought into contact with the base member 16 on two surfaces. The hollow molding 18 is brought into contact with an interior side surface of the base member 16 and a surface of the base member 16, which is away from a surface of the base member 16 in contact with the end surface 12C of the glass plate 12. It should be noted that there is no particular limitation to how the hollow molding 18 is brought into contact with the base member 16. The hollow molding 18 may be brought into contact with the base member on three surfaces or on a single surface. In other words, it is sufficient that the hollow molding 18 is brought into contact with at least one of the interior side surface of the base member 16, the surface of the base member 16 away from the surface of the base member 16 in contact with the end surface 12C of the glass plate 12, or an exterior side surface of the base member 16.

The hollow molding 18 has a hollow portion 20 formed therein so as to extend in a longitudinal direction of the hollow molding 18.

The hollow molding 18 is formed in a hollow structure having the hollow portion 20. When the hollow molding 18 receives a load (such as contact with a door), the hollow molding 18 is deformed, exhibiting an adequate reaction force by collapse of the hollow portion 20 since the hollow portion 20 is included in the hollow molding 18.

The hollow molding 18 and the base member 16 are integrally molded as described later, not fixed together by a double-sided adhesive tape.

### First Embodiment

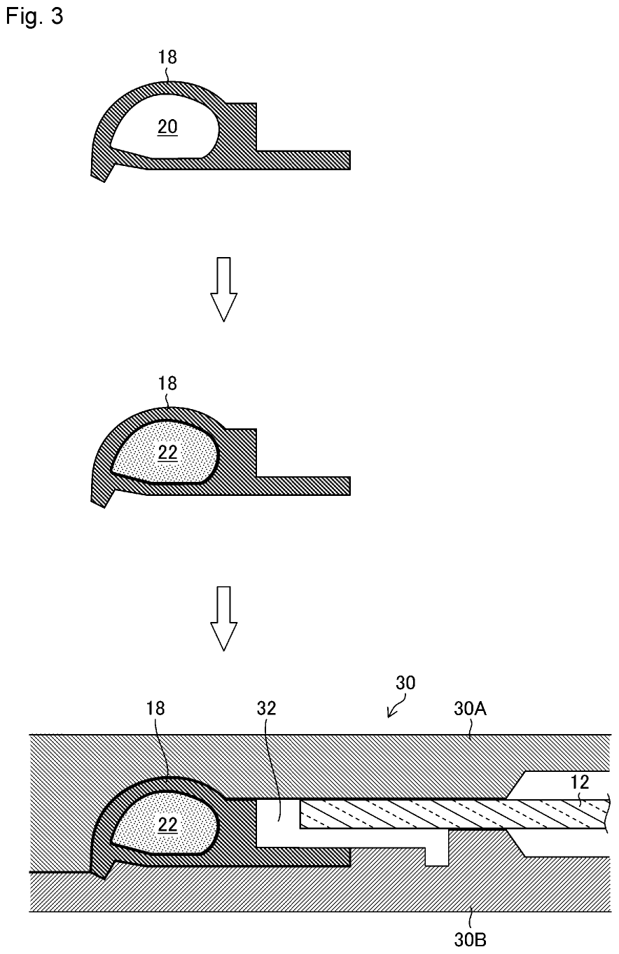

The process for producing a glass plate with a resin frame according to a first embodiment will be described in reference to accompanying drawings. As shown in FIG. 3, the hollow molding 18 having the hollow portion 20 is prepared. There is no limitation to the material forming the hollow molding 18. As the material, an EPDM (ethylene-propylene diene rubber) based material, a resin foaming material, or a thermoplastic elastomer is applicable.

Next, a support member 22 is inserted into the hollow portion 20 in the hollow molding 18. The support member 22 serves to reduce the collapse of the hollow portion 20 and the deformation of the hollow molding 18 in response to load application. The support member 22 preferably has a higher hardness than the hollow molding 18. The support member 22 may be made, for example, of aluminum having a Vickers hardness (HV) of at least 15 measured by the Vickers hardness test prescribed in JIS Z 2244:2009, a metal such as iron having a Rockwell hardness (R scale) of at least 100 measured by the Rockwell test prescribed in JIS Z 2245:2016, or a hard resin (engineering plastic).

The hollow molding 18 has an opening formed in at least one of end surfaces thereof so as to communicate with the hollow portion 20 such that the hollow molding receives the support member 22. The hollow molding 18 is made of an elongated cylindrical member. The term “cylindrical” means a shape having a hollow portion continuously extending therein. The term “elongated” means a shape having a length of at least 100 mm, preferably from 100 mm to 400 mm, in its longitudinal direction.

The glass plate 12 has a portion adjacent to the peripheral edge portion clamped by a mold 30. In this embodiment, the mold includes a top mold 30A and a bottom mold 30B, which are relatively movable to each other. There is no particular limitation to the structure of the mold 30. The mold may include an additional mold or the like. The portion of the glass plate 12 adjacent to the peripheral edge portion ranges within an area of the glass plate 12 inwardly from a position where the base member 16 is attached to the glass plate.

An adhesive (primer) may be applied in advance to an area of the glass plate 12 where the base member 16 is attached to the glass plate 12. Specifically, the adhesive may be applied to both of a peripheral edge portion of the second surface 12B of the glass plate 12 and the end surface 12C of the glass plate 12; or either one of the peripheral edge portion of the second surface 12B or the end surface 12C. When the base member 16 is attached to the first surface 12A as well, the adhesive may be applied to a peripheral edge portion of the first surface 12A. It should be noted that it is optional to apply the adhesive (primer) to an area of the glass plate 12 where the base member 16 is attached.

The glass plate 12 may be made of inorganic glass or organic glass. As the inorganic glass, for example, soda-lime glass, aluminosilicate glass, borosilicate glass, alkali-free glass or quartz glass is applicable without any limitation. The glass plate 12 is preferably made of inorganic glass from the viewpoint of scratch resistance and is preferably made of soda-lime glass from the viewpoint of moldability. When the glass plate 12 is made of soda-lime glass, clear glass, green glass containing a certain amount or more of iron component, UV-cut green glass is appropriately applicable. The glass plate 12 may be made of privacy glass (dark gray glass) having a visible light transmittance of at most 70%. Specifically, the visible light transmittance of the glass plate 12 may be set to at most 70% by controlling the content of total iron in the glass plate 12 in terms of Fe₂O₃.

As an example of the composition of privacy glass, the privacy glass contains, as a glass matrix composition as represented by mass % based on oxides, from 66 to 75% of SiO₂, from 10 to 20% of Na₂O, from 5 to 15% of CaO, from 0 to 6% of MgO, from 0 to 5% of Al₂O₃, from 0 to 5% of K₂O, from 0.13 to 0.9% of FeO, at least 0.8% and less than 2.4% of total iron as represented by Fe₂O₃, and more than 1% and at most 5% of TiO₂, and contains from 100 to 500 mass ppm of CoO, from 0 to 70 mass ppm of Se and from 0 to 800 mass ppm of Cr₂O₃ in a total content of CoO, Se and Cr₂O₃ of less than 0.1 mass % based on the total content of components in the glass matrix composition.

The privacy glass has been described in detail in, for example, WO2015/088026, the entire disclosure of which is incorporated herein by reference in its entirety.

The inorganic glass may be either non-tempered glass or tempered glass. The non-tempered glass is one that is produced by forming molten glass in a plate shape and annealing the formed molten glass. The tempered glass is one that is produced by forming a compressive stress layer in the surface of non-tempered glass.

The tempered glass may be either one of physically tempered glass, such as glass tempered by air quenching, or chemically tempered glass, for example. When physically tempered glass is used, the glass surface may be tempered by, for example, conducting an operation except annealing, so as to quench a glass plate uniformly heated during bending, from a temperature close to its softening point such that a temperature difference is created between the glass surface and the inside of the glass to form a compressive stress layer in the glass surface.

When chemically tempered glass is used, the glass surface may be tempered by, for example, causing a compressive stress in the glass surface by ion exchange treatment or the like after completion of a bending operation. Or glass that absorbs ultra-violet rays or infrared rays may be used. Although the glass plate is preferably transparent, a glass plate that is colored to such a degree not to impair transparency may be used.

The organic glass may be made of a transparent resin including polycarbonate, an acrylic resin such as polymethyl methacrylate, polyvinyl chloride, or polystyrene.

The glass plate 12 may have a scattering prevention film stuck thereon in order to prevent glass pieces from scattering when the glass plate 12 is broken.

There is no particular limitation to the shape of the glass plate 12. The glass plate may be formed in any desired shape or a shape having a desired curvature. The glass plate 12 may be bent by gravity bending, press bending, roller bending or the like. Although there is no particular limitation to how to form the glass plate 12, a glass plate formed by a float process is preferred in connection with organic glass, for example. When the glass plate 12 is made of organic glass having a curved shape, the glass plate 12 is bent after formation by a float process. Bending is conducted in such a state that glass is softened by heating. The temperature for heating the glass during bending is about 500° C. to about 700° C.

When the glass plate 12 is curved, the glass plate may be formed in a single bent shape curved only in a single direction or a compound bent shape curved in two or more directions. When the glass plate 12 is curved, the glass plate is preferably curved so as to be convex toward a vehicle exterior side. When the glass plate 12 is curved, the glass plate 12 has a radius of curvature of preferably at least 1,000 mm and at most 100,000 mm.

The glass plate 12 has a thickness of preferably at least 0.3 mm and at most 5.0 mm, more preferably at least 0.5 mm and at most 3.0 mm, much more preferably at least 0.7 mm and at most 1.9 mm.

The glass plate 12 may have a dark and opaque optically shielding layer (dark ceramic layer), such as a black optically shielding layer, formed in a strip shape along the peripheral edge portion on the second surface 12B. The optically shielding layer achieves the function of shielding the adhesive applied between the glass plate 12 and the base member 16 when the glass plate 12 is mounted to an automobile body. The optically shielding layer may be formed by being baked after application of ceramic paste to a surface of the glass plate 12. The optically shielding layer has a thickness of preferably at least 3 μm and at most 15 μm. Although there is no particular limitation to a width of the optically shielding layer 30, the width is preferably at least 20 mm and at most 300 mm. It should be noted that the glass plate 12 may have a similar optically shielding layer formed along the peripheral edge portion on the first surface 12A as well.

The glass plate 12 may be laminated glass which has a vehicle exterior side glass plate positioned on a vehicle exterior side and a vehicle interior side glass plate positioned on a vehicle interior side, both plates being bonded via an interlayer, when the glass plate is mounted to an automobile. As the interlayer, an interlayer made of polyvinyl butyral (PVB) may be used. When the interlayer is required to have water resistance, the interlayer is preferably made of an ethylene-vinyl acetate copolymer (EVA). The interlayer may be made of an acrylic photopolymerizable prepolymer, an acrylic catalyst polymerizable prepolymer, a photopolymerizable prepolymer of acrylic ester and vinyl acetate, polyvinyl chloride or the like. The vehicle exterior side glass plate and the vehicle interior side glass plate may be the same composition, shape or thickness as each other.

Between an inner surface of the mold 30 and the peripheral edge portion of the glass plate 12 is formed a cavity space 32. The hollow molding 18 with the support member 22 received into the hollow portion 20 is placed apart from the glass plate 12 in the mold. The hollow molding 18 is placed in the mold 30 so as to be apart from the glass plate 12 and to be at least partly exposed to the cavity space 32. In other words, the shape of the cavity space 32 is defined by the inner surface of the mold 30, the glass plate 12 and the hollow molding 18. The cavity space 32 is formed so as to follow the shape of the base member 16.

The adhesive (primer) is preferably applied to a surface of the hollow molding 18, which is exposed to the cavity space 32 of the mold. The adhesive increases the bonding force between the hollow molding 18 and the base member 16 formed of a resin material 40 descried later.

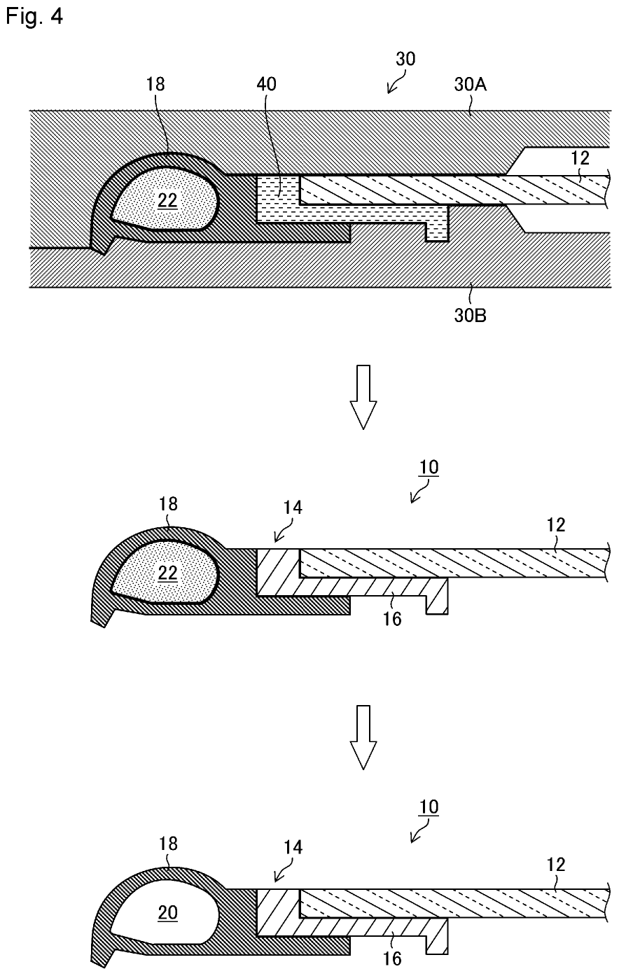

Next, the resin material 40 is injected into the cavity space 32 of the mold 30 as shown in FIG. 4. The resin material is filled in the cavity space 32. The resin material 40 is solidified in the cavity space 32. The hollow portion 20 of the hollow molding 18 is prevented from being deformed, being against the pressure of the resin material 40 injected into the cavity space 32 since the hollow molding 18 has the support member 22 held therein. The hollow molding 18 can maintain its shape until the resin material 40 is solidified after injection.

As the resin material 40, a material such as a thermoplastic resin or a thermosetting resin may be used. The thermoplastic resin is a soft material based on polyvinyl chloride (PVC), a copolymer of vinyl chloride and ethylene, a copolymer of vinyl chloride and vinyl acetate, a copolymer of vinyl chloride and propylene, a copolymer of vinyl chloride, ethylene and vinyl acetate or a mixture of two or more of them compounded with an additive such as a plasticizer, and may be blended with another thermoplastic resin such as chlorinated polyethylene, a urethane-modified vinyl chloride resin, a urethane resin, a polyester resin, a liquid crystal polymer, an acrylic resin, a rubber like NBR (nitri rubber) or SBR (styrene butadiene rubber), an EVA (ethylene-vinyl acetate copolymer), ABS (acrylonitrile-butadiene-styrene copolymer resin) or a mixture of two or more of them. The thermosetting resin may, for example, be polyurethane.

The resin material 40 is solidified to form the base member 16, producing, by the mold 30, a glass plate with a resin frame 10 where the hollow molding 18, the base member 16 and the glass plate 12 are unified.

Then the mold 30 is opened, and the glass plate with a resin frame 10 is taken out of the mold 30.

Finally, the support member 22, which is held into the hollow portion 20 of the hollow molding 18, is taken out through the opening of the hollow molding 18.

In this embodiment, the hollow molding 18 and the base member 16 are integrally molded to the glass plate 12 by injection molding. The hollow molding 18 maintains its shape until the resin material 40 is solidified after injection. Thus, the glass plate with a resin frame 10 is produced with a high attachment accuracy.

### Second Embodiment

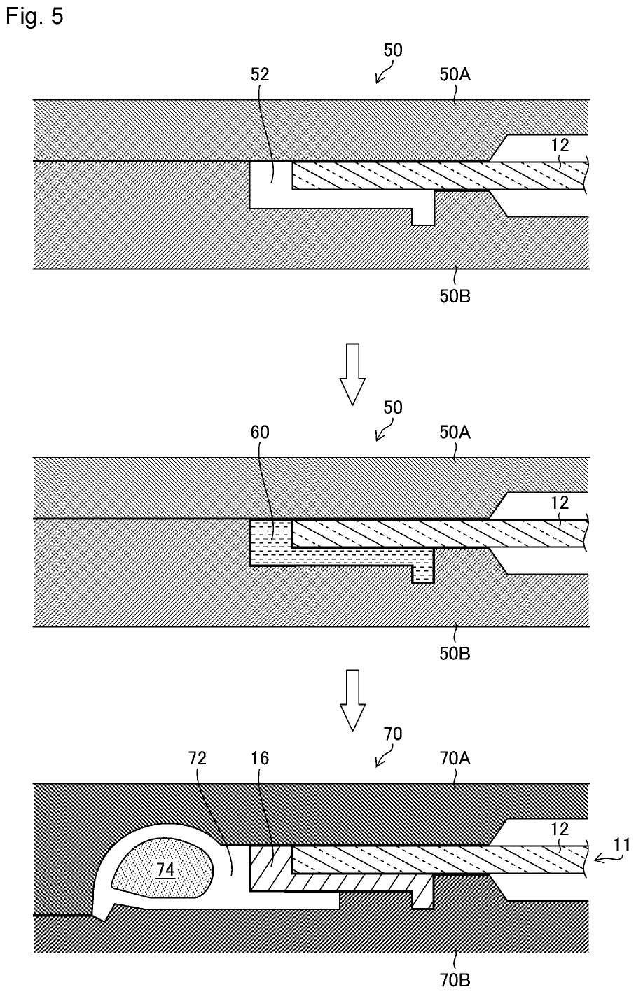

The process for producing a glass plate with a resin frame according to a second embodiment will be described in reference to accompanying drawings. As shown in FIG. 5, the glass plate 12 has a portion adjacent to the peripheral edge portion clamped by a first mold 50. In this embodiment, the first mold 50 includes a top mold 50A and a bottom mold 50B, which are relatively movable to each other. There is no particular limitation to the structure of the first mold 50. Between an inner surface of the first mold 50 and the peripheral edge portion of the glass plate 12 is formed a cavity space 52. The shape of the cavity space 52 is defined by the inner surface of the first mold 50 and the glass plate 12. The cavity space 52 is formed so as to follow the shape of the base member 16. It should be noted that the glass plate 12 used in this embodiment may be a glass plate identical or similar to the glass plate 12 used in the first embodiment.

Next, a first resin material 60 is injected into the cavity space 52 of the first mold 50. The first resin material 60 is filled in the cavity space 52. The first resin material 60 is solidified in the cavity space 52. The first resin material 60 used in this embodiment may be a resin material identical or similar to the resin material 40 used in the first embodiment.

The first resin material 60 is solidified to form the base member 16, producing, by the first mold 50, a glass plate with a base member 11 where the base member 16 and the glass plate 12 are unified.

Next, the glass plate with a base member 11 is taken out of the first mold 50. Then a portion of the glass plate with a base member 11 adjacent to the peripheral edge portion is clamped along with at least a portion of the base member 16 by a second mold 70. In this embodiment, the second mold 70 includes a top mold 70A and a bottom mold 70B, which are relatively movable to each other. It is not essential that the second mold 70 has such a structure.

Between an inner surface of the second mold 70 and the peripheral edge portion of the glass plate with a base member 11 is formed a cavity space 72. In the second embodiment, a support member 74 is disposed in the second mold 70 so as to correspond the shape of the hollow portion 20 of the hollow molding 1 (see FIG. 1).

The shape of the cavity space 72 is defined by the inner surface of the second mold 70, the base member 16 and the support member 74. The cavity space 72 is formed so as to follow the shape of the hollow molding 18. The support member 74 preferably has a higher hardness than the hollow molding 18. The support member 74 may be made, for example, of aluminum having a Vickers hardness (HV) of at least 15 measured by the Vickers hardness test prescribed in JIS Z 2244:2009, a metal such as iron having a Rockwell hardness (R scale) of at least 100 measured by the Rockwell test prescribed in JIS Z 2245:2016, or a hard resin (engineering plastic).

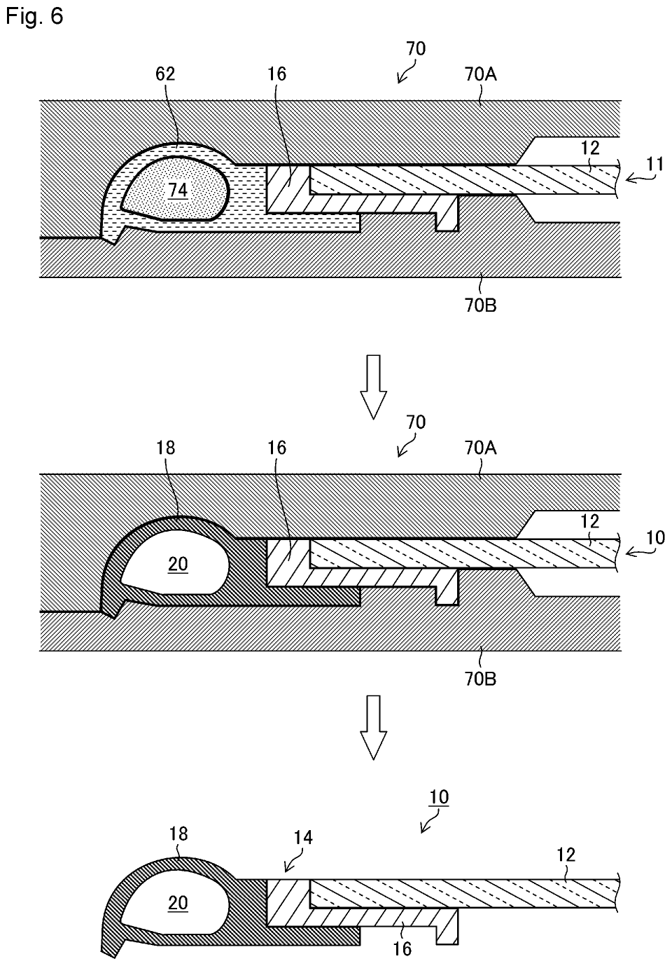

As shown in FIG. 6, a second resin material 62 is injected into the cavity space 72 of the second mold 70. The second resin material 62 is filled in the cavity space 72. The second resin material 62 is solidified in the cavity space 72. As the second resin material 62, a material such as an EPDM (ethylene-propylene diene rubber) based material, a resin foaming material, or a thermoplastic elastomer is applicable.

Next, the support member 74 is taken out of the second mold 70. Thus, the hollow molding 18 is formed so as to include the hollow portion 20, producing, by the first mold 50, a glass plate with a resin frame 10, where the hollow molding 18, the base member 16 and the glass plate 12 are unified. It should be noted that the support member 74 can be taken out through the opening of the hollow molding 18, which is formed in at least one of end surfaces of the hollow molding 18 so as to communicate with the hollow portion 20 of the hollow molding 18.

Finally, the second mold 70 is opened, and the glass plate with a resin frame 10 is taken out of the second mold 70

In this embodiment, the hollow molding 18 and the base member 16 are integrally molded to the glass plate 12 by injection molding. By the second mold 70, the hollow molding 18 is formed by placing the support member 74 in the second mold 70, and injecting and solidifying the second resin material 62 in the second mold. Thus, Thus, the glass plate with a resin frame 10 is produced with a high attachment accuracy.

### Third Embodiment

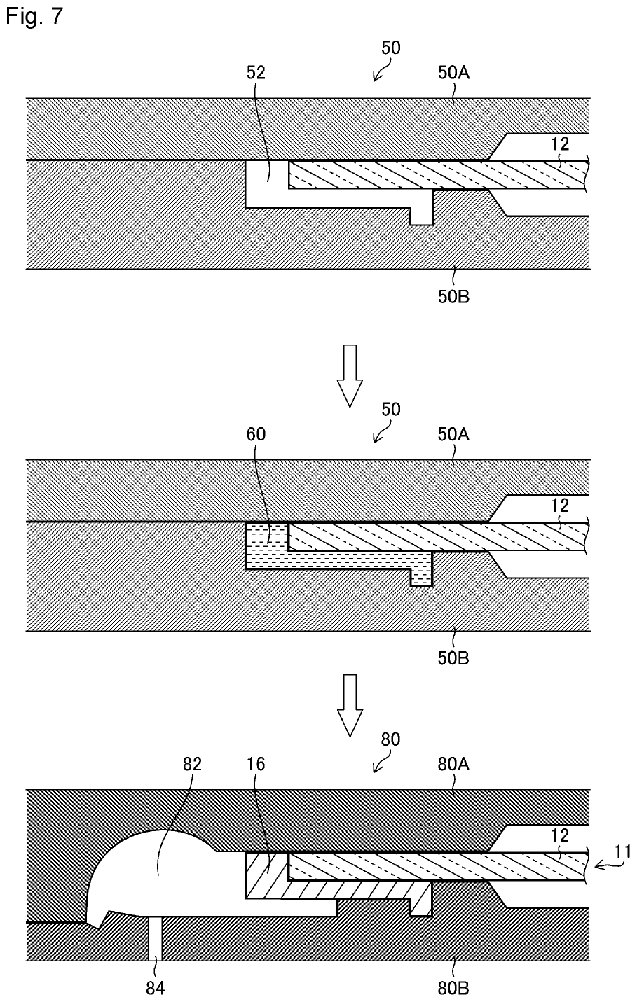

The process for producing a glass plate with a resin frame according to a third embodiment will be described in reference to accompanying drawings. As shown in FIG. 7, the glass plate 12 has a portion adjacent to the peripheral edge portion clamed by a first mold 50. In this embodiment, the first mold 50 includes a top mold 50A and a bottom mold 50B, which are relatively movable to each other. There is no particular limitation to the structure of the first mold 50. Between an inner surface of the first mold 50 and the peripheral edge portion of the glass plate 12 is formed a cavity space 52. The shape of the cavity space 52 is defined by the inner surface of the first mold 50 and the glass plate 12. The cavity space 52 is formed so as to follow the shape of the base member 16. It should be noted that the glass plate 12 used in this embodiment may be a glass plate identical or similar to the glass plate 12 used in the first embodiment.

Next, a first resin material 60 is injected into the cavity space 52 of the first mold 50. The first resin material 60 is filled in the cavity space 52. The first resin material 60 is solidified in the cavity space 52. The first resin material 60 used in this embodiment may be a resin material identical or similar to the resin material 40 used in the first embodiment.

The first resin material 60 is solidified to form the base member 16, producing, by the first mold 50, a glass plate with a base member 11 where the base member 16 and the glass plate 12 are united.

Next, the glass plate with a base member 11 is taken out of the first mold 50. Then a portion of the glass plate with a base member 11 adjacent to the peripheral edge portion is clamped along with at least a portion of the base member 16 by a second mold 80. In this embodiment, the second mold 80 includes a top mold 80A and a bottom mold 80B, which are relatively movable to each other. It is not essential that the second mold 80 has such a structure.

Between an inner surface of the second mold 80 and the peripheral edge portion of the glass plate with the base member 11 is formed a cavity space 82. The shape of the cavity space 82 is defined by the inner surface of the second mold 80 and the base member 16. The cavity space 82 is formed so as to follow the shape of the hollow molding 18.

The second mold 80 according to the third embodiment has a different structure from the second mold 70 according to the second embodiment. The second mold 80 has an injection gate 84 is formed therein so as to be open into the cavity space 82 for the purpose of injecting a gas into the cavity space 82. In this embodiment, the injection gate 84 is formed in the bottom mold 80B. The injection gate 84 may be formed in the top mold 80A.

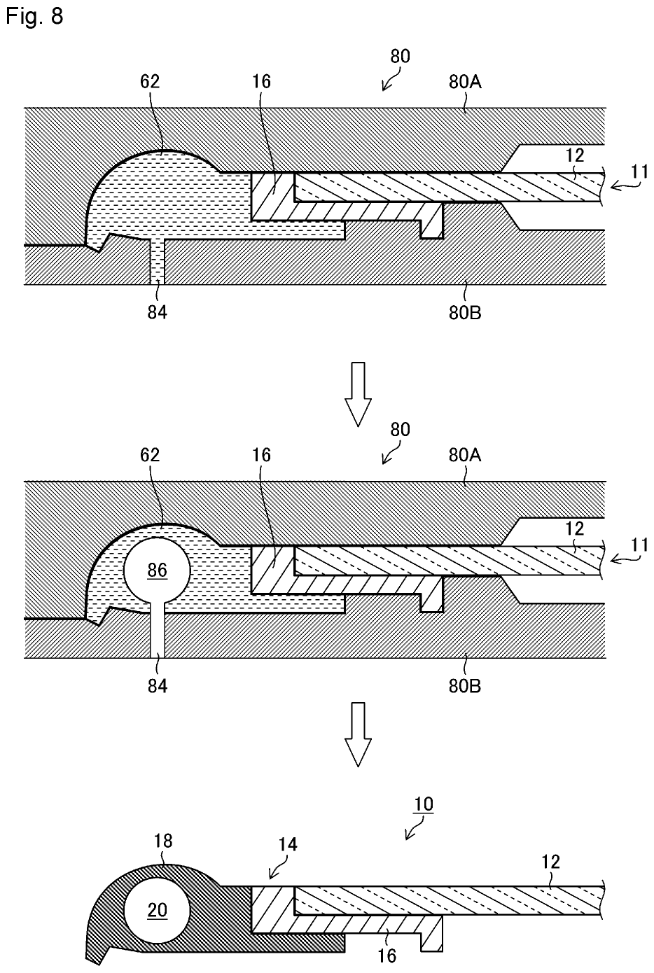

As shown in FIG. 8, a second resin material 62 is injected into the cavity space 82 of the second mold 80. The second resin material 62 is filled in the cavity space 82. The second resin material 62 may be a material identical or similar to the one according to the second embodiment.

Subsequently, the gas (such as a N₂ gas having a high pressure) is introduced into the cavity space 82 through the injection gate 84 before the second resin material 62 filled in the cavity space 82 is solidified. The gas 86 is introduced in the second resin material 62. The second resin material 62 is solidified in the cavity space 82, having the gas 86 introduced therein.

The second resin material 62 is solidified to form the hollow molding 18 with the hollow portion 20, producing, by the second mold 80, a glass plate with a resin frame 10 where the hollow molding 18, the base member 16 and the glass plate 12 are united.

Finally, the second mold 80 is opened, and the glass plate with a resin frame 10 is taken out of the second mold 80.

In this embodiment, the hollow molding 18 and the base member 16 are integrally molded to the glass plate 12 by injection molding. The hollow molding 18 is formed in the second mold 80 by injecting the second resin material 62, followed by injection of the gas and solidification of the second resin material. Thus, the glass plate with a resin frame 10 is produced with a high attachment accuracy.

### Fourth Embodiment

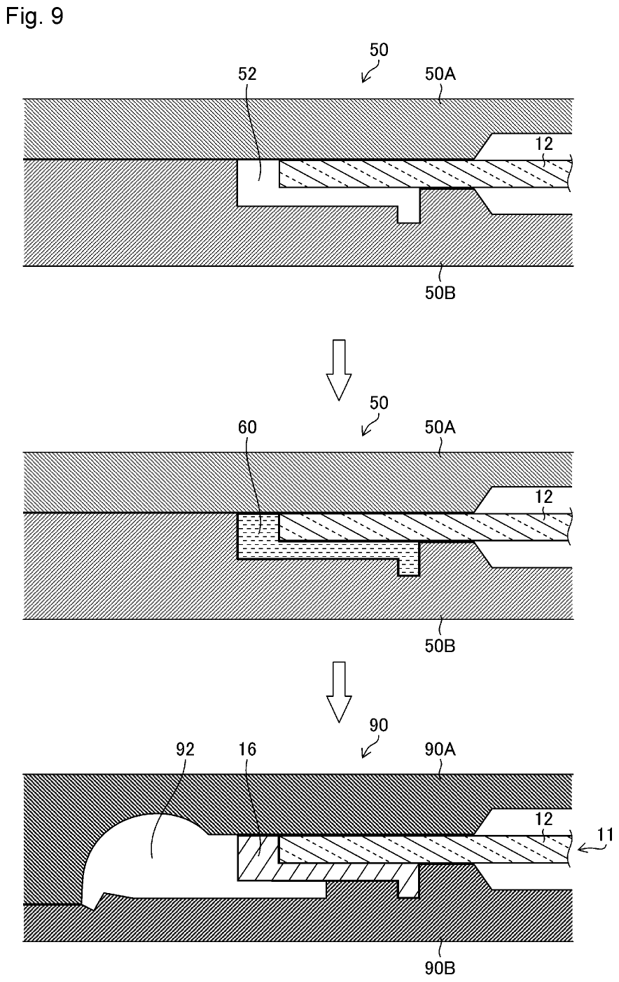

The process for producing the glass plate with a resin frame according to a fourth embodiment will be described in reference to accompany drawings. As shown in FIG. 9, the glass plate 12 has a portion adjacent to the peripheral edge portion clamped by a first mold 50. In this embodiment, the first mold 50 includes a top mold 50A and a bottom mold 50B, which are relatively movable to each other. There is no particular limitation to the structure of the first mold 50. Between an inner surface of the first mold 50 and the peripheral edge portion of the glass plate 12 is formed a cavity space 52. The shape of the cavity space 52 is defined by the inner surface of the first mold 50 and the glass plate 12. The cavity space 52 is formed so as to follow the shape of the base member 16. It should be noted that the glass plate 12 used in this embodiment may be a glass plate identical or similar to the glass plate 12 used in the first embodiment.

Next, a first resin material 60 is injected into the cavity space 52 of the first mold 50. The first resin material 60 is filled in the cavity space 52. The first resin material 60 is solidified in the cavity space 52. The first resin material 60 may be a resin material identical or similar to the resin material 40 used in the first embodiment.

The first resin material 60 is solidified to form the base member 16, producing, by the first mold 50, a glass plate with a base member 11 where the base member 16 and the glass plate 12 are united.

Next, the glass plate with a base member 11 is taken out of the first mold 50. Then a portion of the glass plate with a base member 11 adjacent to the peripheral edge portion is clamped along with at least a portion of the base member 16 by a second mold 90. In this embodiment, the second mold 80 includes a top mold 90A and a bottom mold 90B, which are relatively movable to each other. It is not essential that the second mold 90 has such a structure.

Between an inner surface of the second mold 90 and the peripheral edge portion of the glass plate with a base member 11 is formed a cavity space 92. The shape of the cavity space 92 is defined by the inner surface of the second mold 90 and the base member 16. The cavity space 92 is formed so as to follow the shape of the hollow molding 18.

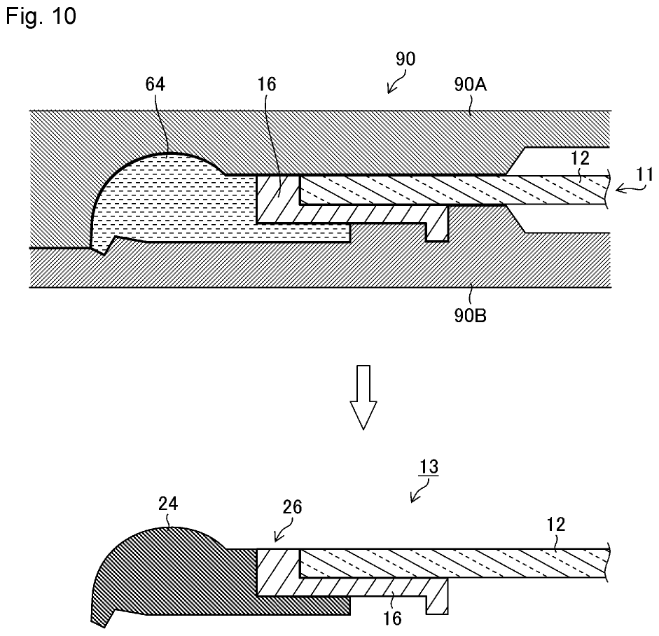

As shown in FIG. 10, a second resin material 64 is injected into the cavity space 92. The second resin material 64 is filled in the cavity space 92. As the second resin material 64, a resin material containing at least a resin foaming material is applicable. The second resin material 64 preferably has a foaming agent kneaded therein. For example, the foaming agent may be supplied to an injection device and is kneaded with the resin material by the injection device. The foaming agent may be a physical foaming agent or a chemical foaming agent. The physical foaming agent means a compound that foams by using a gas generated by the vaporization of the foaming agent. For example, when the pressure in the cavity space 92 drops after injection of the second resin material 64 with a physical foaming agent kneaded therein, the physical foaming agent generates foams, serving as a foaming agent. As the second resin material 64, an olefin-based elastomer resin material, a styrene-based elastomer or the like is applicable. The chemical foaming agent means a compound that generates a gas by thermal decomposition or chemical reaction. As the chemical foaming agent, an organic foaming agent such as azodicarbonamide, N,N′-dinitrosopentamethylenetetramine and 4,4′-oxybisbenzenesulfonyl hydrazide or an inorganic foaming agent such as a hydrogen carbonate salt, a carbonate salt, a mixture of a hydrogen carbonate salt and an organic salt and sodium carbonate hydroxide may be used. As the organic foaming agent, azodicarbonamide or N,N′-dinitrosopentamethylenetetramine is preferred in view of decomposition temperature and gas yield. As the inorganic foaming agent, sodium carbonate hydroxide is preferable for injection molding. In this embodiment, it is preferable to use the chemical foaming agent because it is possible to select an adequate forming agent vaporing at the melting temperature of a resin used as the second resin material 64.

The second resin material 64 is solidified in the cavity space 92. When the second resin material 64 is solidified, a molding having plural foams contained therein 24 is formed, producing, by the second mold 90, a glass plate with a resin frame 13 where the molding 24, the base member 16 and the glass plate 12 are united.

Finally, the second mold 90 is opened, and the glass plate with a resin frame 13 is taken out of the second mold 90. Since the molding 24 contains the plural foams, the molding can be deformed, exhibiting an adequate reaction force as in the hollow molding 18, when a load is applied to the molding.

In this embodiment, a resin frame 26 including the molding 24 and the base member 16 is integrally molded to the glass plate 13 by injection molding. By the second mold 90, the molding 24 is formed by injecting and solidifying the second resin material 64 containing at least a resin foaming material. Thus, the glass plate with a resin frame 13 is produced with a high attachment accuracy.

In the fourth embodiment, the molding 24 may have a hollow portion formed by injecting a gas into the second resin material 64 through an injection gate (not shown) formed at the cavity space 92 of the second mold, before the second resin material 64 filled in the cavity space 92 is solidified.

In the glass plate with a resin frame produced in one of the first embodiment to the fourth embodiment, the surface of the hollow molding or the molding is preferably emboss-finished. The emboss-finished surface serves as reducing the close contact of the hollow molding or the molding with another member.

Some embodiments of the present invention have been described. The present invention should not be construed to be limited to the embodiments described above. Various changes or modification can be made without departing from the spirit and scope of the present invention.

### EXPLANATION OF REFERENCE SYMBOLS

10 and 13: glass plate with resin frame, 11: glass plate with base member, 12: glass plate, 12A: first surface, 12B: second surface, 12C: end surface, 14 and 26: resin frame, 16: base member, 18: hollow molding, 20: hollow portion, 22: support member, 24: molding, 30: mold, 30A: top mold, 30B: bottom mold, 32: cavity space, 40: resin material, 50: first mold, 50A: top mold, 50B: bottom mold, 52: cavity space, 60: first resin material, 62 and 64: second resin material, 70: second mold, 70A: top mold, 70B: bottom mold, 72: cavity space, 74: support member, 80: second mold, 80A: top mold, 80B: bottom mold, 82: cavity space, 84: injection gate, 86: gas, 90: second mold, 90A: top mold, 90B: bottom mold, 92 cavity space

What is claimed is:

1. A process for producing a glass plate with a resin frame, wherein the glass plate has a resin frame disposed on a peripheral edge portion, and the glass plate is configured to be mounted to a vehicle, comprising:
using a mold to clamp a portion of the glass plate adjacent to the peripheral edge portion so as to form a cavity space between an inner surface of the mold and the peripheral edge portion of the glass plate;
placing a hollow molding in the mold so as to be apart from the glass plate and to expose at least a portion of the hollow molding to the cavity space, the hollow molding including a hollow portion and having a support member placed into the hollow portion;
injecting a resin material into the cavity space of the mold, and solidifying the resin material to form a base member so as to produce a glass plate with a resin frame wherein the hollow molding, the base member and the glass plate are unified; taking the glass plate with a resin frame out of the mold; and
removing, out of the hollow portion, the support member placed in the hollow portion.

2. The process according to claim 1, further comprising applying an adhesive to a surface of the hollow molding exposed to the cavity space of the mold.

3. The process according to claim 1, wherein the hollow molding comprises an elongated cylindrical member; and
the hollow molding has an opening formed in at least one of end surfaces so as to communicate with the hollow portion.

4. The process according to claim 1, wherein the support member has a higher hardness than the hollow molding.

5. A process for producing a glass plate with a resin frame, wherein the glass plate has a resin frame disposed on a peripheral edge portion, and the glass plate is configured to be mounted to a vehicle, comprising:
using a first mold to clamp a portion of the glass plate adjacent to the peripheral edge portion so as to form a cavity space between an inner surface of the first mold and the peripheral edge portion of the glass plate;
injecting a first resin material into the cavity space of the first mold, and solidifying the first resin material to form a base member so as to produce a glass plate with a base member wherein the base member and the glass plate are unified;
using a second mold to clamp a portion of the glass plate with the base member, adjacent to the peripheral edge portion, along with at least a portion of the base member, so as to form a cavity space between an inner surface of the second mold and the peripheral edge portion of the glass plate with the base member, injecting a second resin material into the cavity space of the second mold, solidifying the second resin material to form a hollow molding having a hollow portion so as to produce a glass plate with a resin frame wherein the hollow molding, the base member and the glass plate are unified; and
taking the glass plate with a resin frame out of the second mold.

6. The process according to claim 5, wherein the hollow portion of the hollow molding is formed by placing, in the second mold, a support member corresponding to a shape of the hollow portion, followed by solidifying the second resin material injected into the cavity space of the second mold, and removing the support member from the second mold.

7. The process according to claim 6, wherein the hollow molding has an opening formed in at least one of end surfaces so as to communicate with the hollow portion.

8. The process according to claim 6, wherein the support member has a higher hardness than the hollow molding.

9. The process according to claim 5, wherein the hollow portion of the hollow molding is formed by, prior to solidification of the second resin material injected into the cavity space of the second mold, injecting a gas into the cavity space of the second mold and solidifying the second resin material.

10. A process for producing a glass plate with a resin frame, wherein the glass plate has a resin frame disposed on a peripheral edge portion, and the glass plate is configured to be mounted to a vehicle, comprising:
using a first mold to clamp a portion of the glass plate adjacent to the peripheral edge portion so as to form a cavity space between an inner surface of the first mold and the peripheral edge portion of the glass plate;
injecting a first resin material into the cavity space of the first mold, and solidifying the first resin material to form a base member so as to produce a glass plate with a base member wherein the base member and the glass plate are unified;
using a second mold to clamp a portion of the glass plate with the base member, adjacent to the peripheral edge portion, along with at least a portion of the base member, so as to form a cavity space between an inner surface of the second mold and the peripheral edge portion of the glass plate with the base member;
injecting a second resin material into the cavity space of the second mold, the second resin material at least partly containing a resin foaming material, and solidifying the second resin material to form a molding so as to produce a glass plate with a resin frame wherein the molding, the base member and the glass plate are unified; and
taking the glass plate with a resin frame out of the second mold.

11. The process according to claim 10, wherein the second resin material has a foaming agent kneaded therein.

12. The process according to claim 11, wherein the foaming agent comprises a chemical foaming agent.

13. The process according to claim 10, wherein the molding has a hollow portion formed by, prior to solidification of the second resin material, injecting a gas into the second resin material through an injection gate formed at the cavity space of the second mold.
